(19) United States
(12) Patent Application Publication
(10) Pub. No.: US 2024/0327196 A1
(43) Pub. Date: Oct. 3, 2024

(54) DRESSAGE AND POSTURE MARTINGALE FOR HORSES

(71) Applicant: Charles-Alexandre LE GUILLANTON, MONTBARTIER (FR)

(72) Inventor: Charles-Alexandre LE GUILLANTON, MONTBARTIER (FR)

(21) Appl. No.: 18/620,481

(22) Filed: Mar. 28, 2024

(30) Foreign Application Priority Data
Mar. 31, 2023 (FR) 2303175

(51) Int. Cl. B68B 1/04

(52) U.S. Cl. CPC B68B 1/04

(57) ABSTRACT

A dressage and posture martingale including a headstall including a browband and a crownpiece connected to one another, at least one first pressure member mounted on the browband of the headstall so as to come into contact with the frontal-temporal-parietal region of the horse, and at least one second pressure member mounted on the crownpiece so as to come into contact with the occipital-cervical region of the horse, at least the second pressure member being configured to come to bear locally on a predetermined area of the retro-occipital region and to generate a muscular reflex action, in particular of the extensor muscles of the first cervical vertebrae.

The invention concerns dressage and posture martingale for horses intended to act on the attitude of the horse, in particular on the orientation and the level of the neck and the head/neck closing angle to improve its posture and its movement during dressage and to favour the seat of the rider.

### PRIOR ART

Martingales are already known and used.

There are known in particular so-called “WAUTERS” martingales made of leather including a strap fixed at one of its ends to the strap under the belly and bridles bearing respectively on the nose and the poll of the horse and connected to the other end of the strap. Martingales of this kind have only a mechanical action and because of the wide area over which the leather bears on the head of the horse can cause a reverse resistance reaction by the horse and thereby over-contraction of the extensor muscles of the spine, in particular of the cervical spine. The strap for the nose generates a limitation of the opening of the angle of the head relative to the neck when the head is lowered.

Patent application FR2709301A1 describes so-called “RAFFIT” martingales including a leather harness that is fixed to a breastplate on the horse and long lanyards passing through rings at the level of the head and then diverting laterally to the neck to take over from the anterior part of the latter and to be attached to each side of the surcingle. The lanyards are adjusted in such a manner, by bearing on its oesophagus and trachea, as to force the horse to lower its neck in an avoidance movement, flexing the cervical vertebrae. Such martingales create mechanical forces on the trachea and the oesophagus of the horse in an intense and non-proportionate manner, and in particular the horse may have an unexpected reaction.

For their part, “GONIN” martingales include a halter having a wide leather element that bears opposite the second cervical vertebra and a system of cords that are fixed to a strap under the belly of the horse at one end and to the edges of the straps through loops at the level of the nose and the wide leather element. Because of this construction the cords exert an action on the nose which does not allow complete freedom of forward movement of the head.

All these martingales generate mechanical forces on the head or the neck of the horse that lead to a forceful reaction by the horse, which can generate discomfort for the horse, in particular because of the force generated on the cervical vertebrae and/or the thoracic vertebrae and on organs such as the oesophagus and the trachea that are indispensable to its physiology.

Thus there exists the need for improved martingales enabling a posture of the horse with the head lowered to make the horse work while respecting its physiology.

### STATEMENT OF INVENTION

The invention responds to this need by means of a dressage and posture martingale including:
a headstall including a browband and a crownpiece connected to one another,
at least one first pressure member mounted on the browband of the headstall so as to come into contact with the frontal-temporal-parietal region of the horse, and
at least one second pressure member mounted on the crownpiece so as to come into contact with the occipital-cervical region of the horse,
   at least the second pressure member being configured to come to bear locally on a predetermined area of the retro-occipital region and to generate a muscular reflex action, in particular of the extensor muscles of the first cervical vertebrae.

The frontal and crownpieces of the headstall enable the martingale to be held onto the head of the horse around the ears.

The localised bearing on the occipital-cervical region generates a reflex action on the muscles, in particular the extensor muscles of the first cervical vertebrae, favouring the lowering of the neck to avoid this and to favour opening of the angle of the head relative to the neck. This lowering will create an opening out of the vertebral spinous processes and therefore a vertebral arc facilitating the seat of the rider and limiting the so-called “spinous process conflict” pathology.

The localised bearing on the frontal-temporal-parietal region avoids excessive pressure on this region and limits the shear effect that the browband of the headstall could generate in this region. It may also generate an avoidance reflex by the horse.

The downward positioning of the head by the reflex action generated by the second pressure members enables limitation of the high forces on the head of the horse.

Martingales of this kind make it possible to facilitate thoracic-lumbar stretching.

Such martingales are preferably free of members acting on the mouth, and in particular do not include a bit.

The first pressure member is preferably configured to come to bear locally on a predetermined area of the frontal-temporal-parietal region and to generate an avoidance reflex by the horse.

The martingales preferably include a system for at least partially downwardly tensioning the headstall that is connected to the headstall on one side and configured to be connected to something on the horse situated below the neck on the other side, in particular on either side of or between the front legs, in particular a ventral strap.

The headstall tensioning system enables the martingale to have a limiting mechanical action at the top of the poll of the horse. This makes it possible to ensure that the neck descends at least below a top point.

### Headstall

The martingale preferably includes no stress member between the nose of the horse and the headstall, in particular no strap on the nose or connecting members at the level of the jaw. The martingale preferably has nothing on the head except for the headstall.

The fact that only the headstall is present on the head makes it possible not to impede movement of the front of the head. The horse is then able to advance the tip of the nose freely.

This freedom of movement of the head combined with the retention of the headstall and the localised bearing of the second pressure member on the crownpiece will limit the tension on the supra spinous process ligament by allowing extension of the first cervical vertebrae, which facilitates the mobility of the lumbar vertebrae in the movement and limits the collapse of the last cervical vertebrae and the first thoracic vertebrae.

It is also possible to get the horse to work on its attitude while enabling it to retain a physiological posture.

The crownpiece of the headstall is preferably configured to be positioned behind the ears in the zone from the occipital to the second cervical vertebra, otherwise called the “axis” or C2 vertebra, and preferably on the first cervical vertebra, also called the “atlas” or C1 vertebra.

The front part of the headstall is preferably configured to be positioned in front of the ears on the frontal, parietal and temporal bones of the horse.

The browband and the crownpiece of the headstall are each formed at least partly of a cord with a diameter between 2 mm and 15 mm inclusive, better between 4 mm and 12 mm inclusive, even better between 5 mm and 7 mm inclusive, or a strap with a width between 2 mm and 10 cm inclusive, better between 4 mm and 6 cm inclusive, even better between 1 cm and 3 cm inclusive. Such dimensions make it possible to limit injuries caused by shear in the event of unexpected movements and avoids pressure over too great a width, which limits the risk of a resisting reverse muscular contraction by the horse.

The browband and the crownpiece of the headstall are preferably made of cord and not of leather.

The browband and the crownpiece of the headstall are interconnected by connecting parts that can be of any shape, in particular by a connecting notch or loop, configured to come laterally on either side of the ears.

The browband of the headstall, the crownpiece of the headstall and/or the connecting parts may include at least one protecting sheath at least partly covering the cord. The protecting sheath may be made of foam, leather, fleece, neoprene, rubber, Kevlar, nylon, leather, braided or non-braided reinforced synthetic fibres or plastic, in particular heatshrink plastic. This in particular makes it possible to improve the comfort of the horse and/or to increase the stiffness of the cord in these areas.

### Pressure Member

The martingale preferably includes a plurality of first pressure members and a plurality of second pressure members that are not connected, in particular two first and two separate second pressure members.

The first and second pressure member or members is/are preferably configured so that the pressure is localised.

The first and second pressure member or members may each be localised raised portions on the browband and crownpiece of the headstall, in particular one or more knots in a cord or strap forming the browband and the crownpiece of the headstall or one or more raised elements, such as balls, attached to the browband and crownpiece of the headstall.

The first and second pressure member or members preferably have a greatest transverse dimension between 2 cm and 7 cm inclusive, better between 2 cm and 4 cm inclusive.

In the case of a plurality of first pressure members, in particular two first pressure members, they may be spaced from one another on the browband of the headstall by a distance between 2 cm and 16 cm inclusive, better between 2 cm and 14 cm inclusive, even better between 4 cm and 13 cm inclusive, preferably between 4 cm and 8 cm inclusive, the distance being measured between the facing edges of the first pressure members.

In the case of a plurality of first pressure members, in particular two first pressure members, they may be spaced on the browband of the headstall by a distance between 2 cm and 16 cm inclusive, preferably between 4 cm and 13 cm inclusive, the distance being measured between the middle of the first pressure members and the edges of the first pressure members closest to the middle.

In the case of a plurality of second pressure members, in particular two second pressure members, they may be spaced on the crownpiece of the headstall by a distance between 1 cm and 18 cm inclusive, better between 2 cm and 15 cm inclusive, even better between 4 cm and 9 cm inclusive, the distance being measured between the facing edges of the second pressure members. This in particular enables limitation of the tension in the nuchal ligament.

The first and second pressure member or members may be fixedly mounted on the browband and crownpiece of the headstall. Alternatively, the first and second pressure member or members are adjustable in position on the browband and crownpiece of the headstall to adapt to the morphology of the horse. In the case of attached elements, in particular balls, the latter may be fixed by knots in the cord or the strap forming the browband and crownpiece of the headstall.

The first and second pressure member or members are preferably fixed in position during use of the martingale, whether adjusted beforehand or not. This is in order to avoid movement of the pressure points.

The martingale may further include at least two lateral pressure members mounted on the headstall, in particular on the browband so as to extend laterally on either side of the head of the horse and in contact with the temporal regions of the horse, in particular facing the temporal bones of the horse. Such lateral pressure members make it possible to limit the pressure of the headstall on the head, in particular at the level of the ears. This improves the comfort of the horse and reduces the risks of reaction by the horse. The lateral pressure members may be as described above in the case of the first and/or the second pressure member or members.

The lateral pressure members can be spaced from the connection between the browband and the crownpiece of the headstall by a distance less than or equal to 10 cm, better between 1 cm and 6 cm inclusive, the distance being measured between the edge nearest the connection and the centre of the connection.

### Tension System

The tension system is preferably connected to the headstall on either side of the head, in particular at the level of the parts connecting the browband with the crownpiece. The tension system may be mounted on the headstall by fixed or removable fastenings, in particular on the parts connecting the forehead part with the crownpiece, or be formed by lateral extensions of the headstall, in particular of the cord or of the strap forming the browband or the crownpiece of the headstall.

The tension system may be fixed to or removable from the headstall.

The tension system preferably includes at least one removable member for fastening it to something on the horse situated below the neck, in particular to a ventral strap.

Alternatively, the tension system includes a strap or a cord, a removable fastening member at its end and at least one position where the removable fastening member is attached to the cord or to the strap so that the user can pass the tension system through a loop formed by or on what is on the horse and situated below the neck, in particular between the belly and the ventral strap, and attach the removable fastening member to the attachment point. The tension system include a plurality of these attachment positions.

The tension system may include a system for adjustment of its length. Such an adjustment system may be a belt-type system or formed by a plurality of attachment positions on the tension system of the removable fastening member. The tension system preferably has a maximum usable length between 50 cm and 170 cm, better between 110 cm and 155 cm and even between 120 cm and 145 cm. The tension system preferably has a minimum usable length between 20 cm and 120 cm, better between 30 cm and 90 cm and even better between 40 cm and 80 cm, preferably between 60 cm and 80 cm.

The adjustment system may include attachment holes or positions spaced from one another by a distance between 2 cm and 15 cm inclusive, better between 5 cm and 12 cm inclusive. The adjustment system may have a maximum length between 30 cm and 120 cm inclusive, better between 60 cm and 110 cm inclusive. The adjustment system may have a minimum length between 5 cm and 50 cm inclusive, better between 5 cm and 20 cm inclusive. The attachment holes or positions may be spaced from one another by a distance between 5 cm and 20 cm inclusive, better between 5 cm and 15 cm inclusive.

The tension system may include two parts each connected to the headstall on one side of the head of the horse at one of their ends and connected to one another at their other end, in particular by connecting them to the adjustment system.

The tension system is preferably flexible and adjustable. This allows free movement of the head below the high point defined by the length of the adjustable tension system.

Alternatively, the tension system is rigid. This can make it possible to avoid insufficient stimulation of the pressure members and contraction of the dorsal muscles.

The adjustment system and the part of the tension system between the adjustment system and the headstall are preferably not made of elastic material. They may be made of cord, leather or any other appropriate material.

Alternatively or additionally, the tension system may include at least one elastic part.

The tension system may include an elastic part in parallel with the adjustment system on the tension system onto which the fixing member may alternatively be fixed. This makes it possible, by virtue of the capacity for lengthening, to minimise at will inappropriate reactions by the horse. This may be better for working when mounted and warming up the horse. This elongation capacity can remain small in order not to limit the effect of the pressure members.

Alternatively or additionally the tension system may include an elastic or non-elastic part extending lengthwise in the tension system, in particular continuous with the adjustment system. Said elastic part may connect to knots of the adjustment system by moving them closer to the elastic part when not under tension. The connection between the headstall and what is on the horse below the neck therefore has an elongation capacity enabling freeing of the length under tension, which limits the force of the reaction by the horse and enables better respect for the physiology of the horse. Moreover, an elastic part of this kind can make it possible to facilitate removing the martingale from the horse by offering a clearance useful for unhooking the martingale from the bottom fixing area. The tension system with the elastic part preferably has a maximum elongation capacity between 2 cm and 10 cm inclusive, better between 4 cm and 6 cm inclusive.

The tension system may include a safety system configured to detach the tension system or to release the tension generated by the tension system if a tension greater than a predetermined tension is applied to it. The safety system may be a safety ring, in particular a split ring, the yield strength of which is substantially equal to the predetermined force. The safety system may be integrated into the removable fastening member or the adjustment system or arranged elsewhere in the tension system, in particular at the junction of the tension system with the connecting part of the headstall and the adjustment system. The predetermined force may be between 15 kg and 130 kg inclusive, preferably from 35 kg to 90 kg. In the event of an unexpected reaction by the horse, such a safety system enables detachment of the tension system facilitating working when mounted and limiting the risks of injuries to the horse linked to the tension system.

### Attachment System

The martingale may include one or more attachment systems, in particular on the crownpiece of the headstall, for fixing the headstall to something on the horse, in particular to the bridle, halter or mane of the horse. The attachment system or systems may be mounted in a fixed or removable manner. They enable attachment to the horse that limits or even prevents the risks of removal of the martingale by an unexpected movement of the horse. This also enables retention of the pressure members in position despite movements of the head of the horse, in particular lowering of the head of the horse.

The attachment system or systems may consist of hook-and-loop fasteners or cords or be made of leather or any other material.

The attachment system or systems is or are preferably fixed between the two second pressure members. Alternatively, they are placed laterally on either side of the second pressure member or members. The part of the junction area on the headstall between the headstall, in particular the crownpiece, and the attachment system or systems preferably includes a protective sheath, in particular a plastic sheath.

The attachment system or systems may have a width between 0.5 cm and 6 cm inclusive, preferably between 1 cm and 5 cm inclusive, preferably between 2 cm and 4 cm inclusive. The attachment system or systems may have a length between 3 cm and 17 cm inclusive, preferably between 6 cm and 14 cm inclusive.

The invention also concerns a method of training a horse with the aid of the martingale as described above including positioning the headstall on the head of the horse with the first or second pressure member or members in the corresponding area(s), in particular in area(s) in which they generate an avoidance reflex action, in particular on extensor muscles of the first cervical vertebrae in the case of the second pressure members.

The method may include adjusting the position of the pressure member or members depending on the morphology of the horse.

The method may include attaching the tension system to what is on the horse below the neck.

The method may include adjustment of the length of the tension system depending on the morphology of the horse.

The method may include fixing the fixing member onto an elastic part of the tension system parallel to the adjustment system.

Alternatively or additionally the method may include the possibility of lengthening the tension system by means of an elastic part of the tension system, in particular one continuous with the adjustment system.

### BRIEF DESCRIPTION OF THE DRAWINGS

FIG. 1A represents diagrammatically one example of a martingale in accordance with the invention,

FIG. 1B represents diagrammatically one example of a martingale in accordance with the invention,

FIG. 2 represents diagrammatically an example of mounting a martingale in accordance with the invention on a horse as seen from the side,

FIG. 3 represents diagrammatically an example of mounting a martingale in accordance with the invention on a horse as seen from the front,

FIG. 4 represents diagrammatically an example of mounting a martingale in accordance with the invention on a horse as seen from the back,

FIG. 5 represents an example of a martingale in accordance with the invention mounted on a horse undergoing training,

FIG. 6 represents details of a headstall in accordance with the invention,

FIG. 7 represents diagrammatically a variant martingale in accordance with the invention.

### DETAILED DESCRIPTION

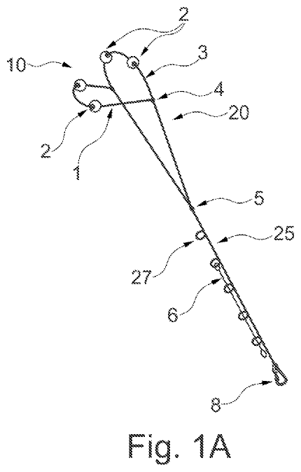

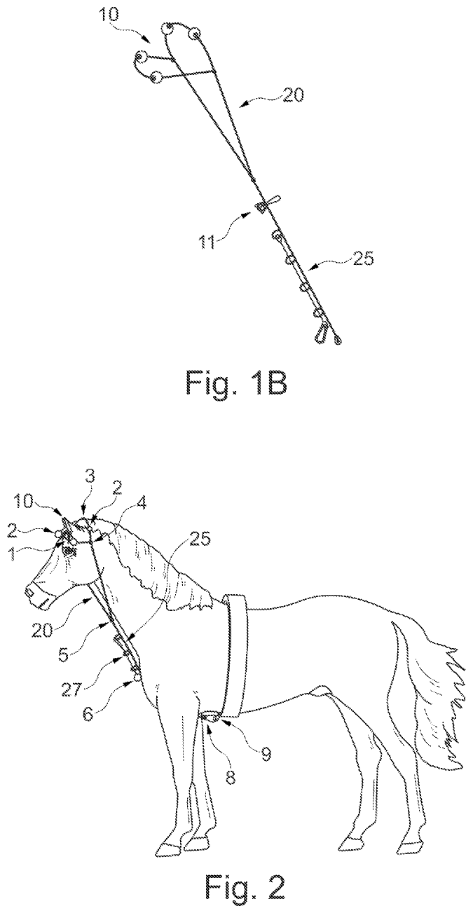

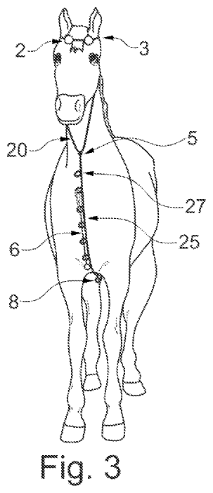

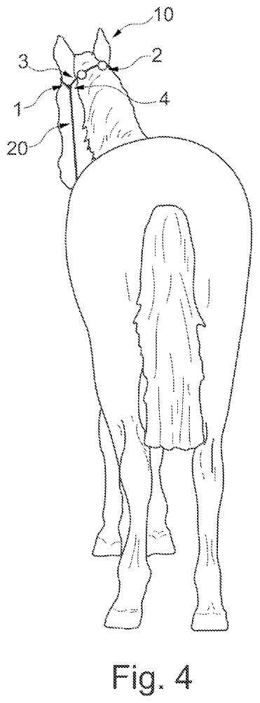

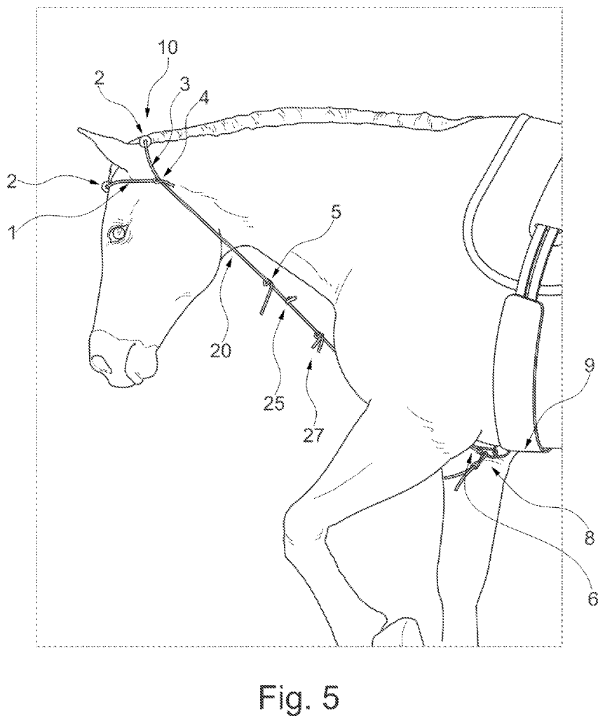

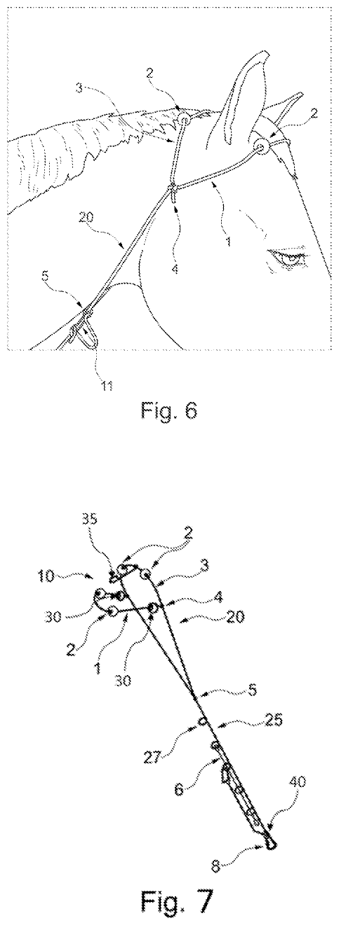

There have been depicted in FIGS. 1 to 6 martingales including a headstall 10, first and second pressure members 2 mounted on the headstall 10 and, in the situation depicted, a system 20 for tensioning the headstall connecting the headstall 10 to a strap 9 at the level of the belly of the horse between the front legs. The headstall includes a browband 1 configured to be positioned in front of the ears in a frontal, templar and/or parietal area and a crownpiece 3 positioned behind the ears and the occiput in the occipital area at the second cervical vertebra, otherwise called the “axis” or C2 vertebra, and preferably at the first cervical vertebra, otherwise called the “atlas” or C1 vertebra. The parts 1 and 3 of the headstall are preferably each a cord with a diameter between 5 mm and 12 mm inclusive or a strap with a width between 1 cm and 3 cm inclusive. The two parts 1 and 3 of the headstall are connected to one another on either side of the ears of the horse by connecting parts 4, in particular in the form of connecting knots or loops. The first pressure members 2, of which there are preferably two, are mounted on the browband 1. The second pressure members 2, of which there are preferably two, are mounted on the crownpiece 3 of the headstall so as to generate an avoidance reflex reaction because of their localised contact with precise predetermined zones, in particular on the extensor muscles of the first cervical vertebrae. The first and second pressure members 2 preferably take the form of balls mounted on the corresponding part 1 or 3 of the headstall and fixed in position by knots in the corresponding part 1 or 3 of the headstall or by any other means. Alternatively, they could take the form of knots in the cord or the strap of the corresponding part 1 or 3 of the headstall or the form of any raised part on the corresponding part 1 or 3 of the headstall enabling local pressure on predetermined localised areas. They may have a greatest transverse dimension between 2 cm and 4 cm inclusive.

The first and second pressure members may be adjustable in position depending on the morphology of the horse to be fitted, in particular by movement of the knots or other elements immobilising the balls.

When there are two of them the first and second pressure members may be spaced by at least 2 cm.

The tension system 20 includes two cords or straps connecting it to the headstall, which can be mounted on the connecting parts 4 of the headstall or continuous with the cord or the strap of one of the two parts 1 and 3 of the headstall, being connected to one another by a junction 5 at the mid-neck, in particular facing the third to fifth cervical vertebrae. The tension system 20 also includes a system 25 for adjusting the length of the tension system 20 extending between the junction 5 and a fixing member 8 configured to be fixed to a low element on the horse, in particular a ventral strap 9 of a saddle or a surcingle, passing between the front legs of the horse. The adjustment system may include a plurality of attachment knots 27 spaced from one another by a distance between 5 cm and 10 cm inclusive, better between 2 cm and 6 cm inclusive. The adjustment system 25 may include a member 8 for attachment to this low element that can be positioned on any of the attachment knots 27 depending on the required length of the tension system, which depends on the action required at the level of the headstall.

The adjustment system is preferably made of a substantially non-elastic material, in particular in the form of a cord or strap.

The tension system 20 may include an elastic part 6 in parallel with the adjustment system 25 that can be attached to the junction and to each attachment knot 27. It is then possible to attach the attachment member 8 to the elastic part to obtain the benefit of the elongation capacity and to minimise unexpected reactions by the horse, in particular when it is fitted or during warming up and first use.

The cords or straps forming the parts 1 and 3 of the headstall and/or of the tension system 20 may be bare or at least partly covered by one or more sheaths, in particular made of heatshrink plastic material. Such sheaths can make it possible to protect the horse from rubbing.

In an alternative depicted in FIG. 1B the tension system 20 includes an elastic part 11, in particular between two attachment knots of the adjustment system, bringing them closer together when not lengthened, continuous with the adjustment system 25, enabling an elongation capacity of the tensioning system of between 4 cm and 6 cm inclusive at most. Such an elastic part enables a forceful reaction by the horse and better respect for the physiology of the horse.

In an alternative depicted in FIG. 7 the headstall 10 further includes two lateral pressure members 30 extending over the browband 1 on either side of the head of the horse. The lateral pressure members 30 may come to bear against the temporal part of the head facing the temporal bone and making it possible to limit the pressure of the headstall at the level of the ears. They are arranged near the connecting parts 4.

Moreover, the martingale includes an attachment system 35 fixed to the centre of the crownpiece to enable attachment to something on the horse, in particular a halter, a bridle or the mane. It could nevertheless be fixed to the headstall somewhere else. The invention is not limited to a single attachment system, which could be duplicated, that is to say include a plurality of points of connection to the headstall.

The adjustment system 25 includes a cord or strap passing through the fastening member 8 and having a return fixed to the attachment knots or loops 27. It is then easy to adjust the length of the adjustment system by attaching the return to one or other of the knots or loops.

The tensioning system 20 includes a safety system 40, here a safety split ring, configured to free at least partially the tensioning system when the tension exerted on the latter is greater than or equal to a predetermined value. The predetermined value may be between 35 kg and 90 kg. Here the security system 40 is positioned at the level of the attachment to the ventral strap, but it could be positioned somewhere else, in particular at the level of the connection 5 or of the attachment of the return to the corresponding knot or loop. The safety system is adapted to break or to separate.

The invention is not limited to the example that has just been described. For example, the adjustment system may include any other means for adjusting the length of the tensioning system, in particular a belt-type system. Part of the martingale, in particular of the tensioning system, may be elastic.

1. A dressage and posture martingale including:
a headstall including a browband and a crownpiece connected to one another,
at least one first pressure member mounted on the browband of the headstall so as to come into contact with the frontal-temporal-parietal region of the horse, and
at least one second pressure member mounted on the crownpiece so as to come into contact with the occipital-cervical region of the horse,
at least the second pressure member being configured to come to bear locally on a predetermined area of the retro-occipital region and to generate a muscular reflex action, in particular of the extensor muscles of the first cervical vertebrae.

2. The martingale according to claim 1 with no constraint member between the nose of the horse and the headstall, in particular no strap on the nose or connecting members at the level of the jaw.

3. The martingale according to claim 1 including a plurality of first pressure members and a plurality of second pressure members separate from one another, in particular two first pressure members and two second pressure members separate from one another.

4. The martingale according to claim 1 in which the first and second pressure member or members are one or more knots in a cord or a strap forming the browband and the crownpiece of the headstall or one or more raised elements, such as balls, mounted on the browband and the crownpiece of the headstall.

5. The martingale according to claim 1 in which the browband and the crownpiece of the headstall are each formed either by a cord with a diameter between 2 mm and 15 mm inclusive, better between 4 mm and 12 mm inclusive, even better between 5 mm and 7 mm inclusive, or a strap with a width between 2 mm and 10 cm inclusive, better between 4 mm and 6 cm inclusive, even better between 1 cm and 3 cm inclusive.

6. The martingale according to claim 1 in which the pressure member or members are adjustable in position on the browband and the crownpiece of the headstall to adapt to the morphology of the horse.

7. The martingale according to claim 1 including a system for at least partially downwardly tensioning the headstall connected to the headstall on one side, in particular on either side of the head at the level of the parts connecting the browband with the crownpiece, and configured to be connected to something on the horse below the neck on the other side, in particular on either side of or between the front legs, in particular a ventral strap.

8. The martingale according to claim 7 in which the tension system includes a system for adjusting its maximal length between 50 cm and 170 cm, better between 110 cm and 155 cm and even better between 120 cm and 145 cm.

9. The martingale according to claim 7 in which the tension system includes a safety system configured to detach the tension system or to release the tension generated by the tension system if a tension greater than a predetermined tension is applied to it.

10. The martingale according to claim 1 further including at least two lateral pressure members mounted on the headstall, in particular the browband, so as to extend laterally on either side of the head of the horse in contact with the temporal region of the horse, in particular facing the temporal bone of the horse.

11. The martingale according to claim 1 including one or more attachment system in particular arranged on the crownpiece of the headstall for fixing the headstall to something on the horse, in particular to the bridle, halter or mane of the horse.

12. A method of training a horse using the martingale according to claim 1 including positioning the headstall on the head of the horse and positioning the first and second pressure member or members on the corresponding area(s), in particular area(s) in which they generate an avoidance reflex action, in particular on extensor muscles of the first cervical vertebrae in the case of the second pressure members.

13. The method according to claim 12 including adjustment of the position of the pressure member or members depending on the morphology of the horse.

14. The method according to claim 12 using the martingale according to claim 9 including fixing the tension system to the element on the horse below the neck.

15. The method according to claim 12 including the possibility of lengthening the tension system by means of an elastic part of the tension system.
